(19) United States
(12) Patent Application Publication
(10) Pub. No.: US 2017/0031470 A1
(43) Pub. Date: Feb. 2, 2017

(54) TOUCH PEN WITH COLOR ADJUSTMENT

(71) Applicant: Sihwan CHAE, Yongin-si (KR)

(72) Inventor: Sihwan CHAE, Yongin-si (KR)

(21) Appl. No.: 15/206,401

(22) Filed: Jul. 11, 2016

(30) Foreign Application Priority Data
Jul. 28, 2015 (KR) 10-2015-0106579

(51) Int. Cl. G06F 3/0354; G06F 3/038

(52) U.S. Cl. CPC G06F 3/03546; G06F 3/0383; G06F 3/0386; G06F 3/03542

(57) ABSTRACT

The present disclosure provides a touch pen with a color control function, wherein the touch pen is communicatively paired with a user touch display device, wherein the touch pen allows a user input to be written on the display device, wherein the touch pen comprises: an elongate body; a communication unit configured to communicate with the user touch display device; at least one moveable member disposed moveably on the body, wherein the movement of the moveable member on the body controls a color of the user input to be rendered on the display device; and a controller configured to generate a color control signal corresponding to the movement of the moveable member and to send the color control signal via the communication unit to the touch display device.

This application claims the benefit of Korea Patent Application No. 10-2015-0106579 filed on Jul. 28, 2015, the entire content of which is incorporated herein by reference for all purposes as if fully set forth herein.

### BACKGROUND

Field of the Present Disclosure

The present disclosure relates to a touch pen with a color control function, wherein the touch pen is communicatively paired with a user touch display device.

Discussion of the Related Art

With a wide and rapid spread of a touch display device, a student uses a touch pen to write an input thereof on the touch display device for a study. In order to improve a memo visible effect, the student chooses various colors, line thickness, color brightness, and/or chorma. However, when the user uses a currently available interface from various write applications, operations of controlling the various colors, line thickness, color brightness, and/or chorma thereon may be difficult. Further, the user may forget the selected colors, line thickness, color brightness, and/or chorma.

### SUMMARY

Thus, the present disclosure is to provide a touch pen with a color control function to allow operations of controlling various colors, line thickness, color brightness, and/or chorma to be easy.

In one aspect, the present disclosure provides a touch pen with a color control function, wherein the touch pen is communicatively paired with a user touch display device, wherein the touch pen allows a user input to be written on the display device via a contact with or a proximity thereof to the display device, wherein the touch pen comprises: an elongate body; a communication unit configured to communicate with the user touch display device; at least one moveable member disposed moveably on the body, wherein the movement of the moveable member on the body controls a color of the user input to be rendered on the display device; and a controller configured to generate a color control signal corresponding to the movement of the moveable member and to send the color control signal via the communication unit to the touch display device.

In one embodiment, the moveable member moves between a first position and second position, wherein the movement of the member to one of the first and second positions allows a predetermined color of the user input to be rendered on the display device, and the movement of the member to the other of the first and second positions disables the rendering of the predetermined color of the user input on the display device.

In one embodiment, the at least one moveable member includes plural moveable members corresponding to different colors respectively, wherein the movements of the moveable members on the body controls the corresponding colors of the user input to be rendered on the display device.

In one embodiment, the movement of the moveable member on the body selects a color of the user input to be rendered on the display device.

In one embodiment, the movement of the moveable member on the body adjusts a color brightness, a color chorma and/or a line thickness of the user input to be rendered on the display device.

In one embodiment, the pen further comprises a LED (light emitting device) to emit a light beam having a color attribute corresponding to a color attribute of the controlled color of the input on the display device.

In one embodiment, the pen further comprises a mode selection unit to be configured to switch between write and erase modes.

In one embodiment, the pen further comprises a geometry write unit configured to activate or deactivate a geometry write mode on the touch display device.

In accordance with the present disclosure, the touch pen with the color selection or adjustment function may allow the user to control the color, line thickness, color brightness and/or chroma of the user input on the touch display device using the moveable member or button disposed on the touch pen. This may provide the user with the easiness to control the input image or content on the write application, for example, installed on the smart phone or tablet. Further, since the LED of the touch pen emits the color corresponding to the selected color by the moveable member, the user may perceive the selected color intuitively without checking the rendered color on the write application.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a block diagram of a configuration of a touch pen in accordance with one embodiment of the present disclosure.

FIG. 2 shows a perspective view of a touch pen in accordance with one embodiment of the present disclosure.

FIG. 3 shows a color adjustment unit of a touch pen in accordance with one embodiment of the present disclosure.

FIG. 4 shows an adjustment method of line thickness, color brightness or chroma using a touch pen in accordance with one embodiment of the present disclosure.

FIG. 5 shows states of variable line thicknesses embodied using a touch pen in accordance with one embodiment of the present disclosure.

FIG. 6 shows states of variable color brightness embodied using a touch pen in accordance with one embodiment of the present disclosure.

FIG. 7 shows a user touch display device communicatively connected to a touch pen in accordance with one embodiment of the present disclosure.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,”“below,”“lower,”“under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, embodiments of the present disclosure will be described in details with reference to attached drawings.

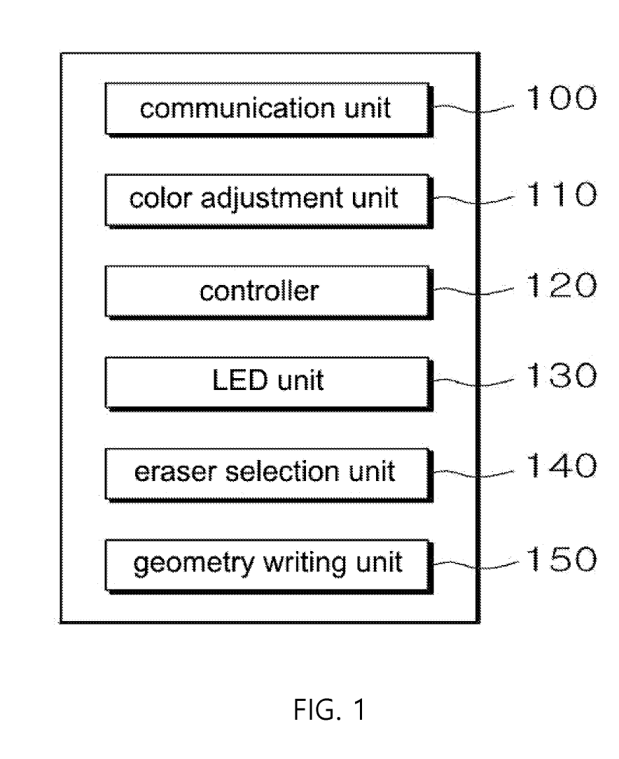

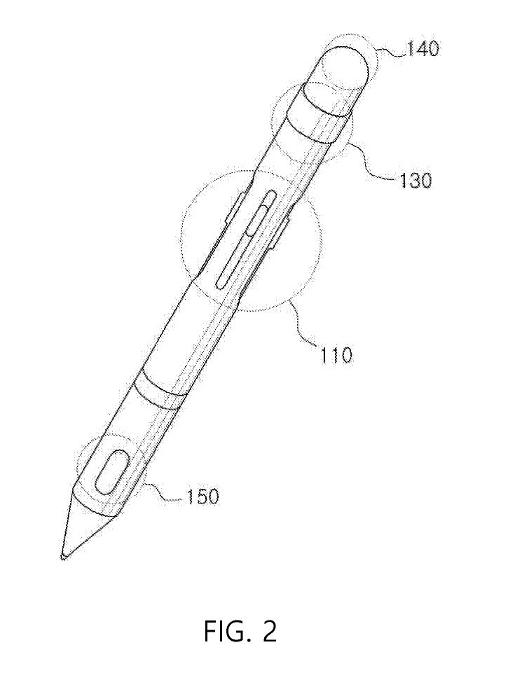

FIG. 1 shows a block diagram of a configuration of a touch pen in accordance with one embodiment of the present disclosure. FIG. 2 shows a perspective view of a touch pen in accordance with one embodiment of the present disclosure. Referring to FIG. 1, a touch pen in accordance with one embodiment of the present disclosure may include a communication unit 100, a color adjustment unit 110, and a controller 120. Optionally, the touch pen may include a LED unit 130, an eraser selection unit 140 and/or a geometry writing unit 150.

The communication unit 100 may be paired with a user touch display device via a short distance wireless communication and then send data thereto. The short distance communication may include, but not limited to, Bluetooth, Zigbee, Wi-Fi Wireless Fidelity, WiGig, Wireless Gigabit, Beacon, etc. Alternatively, the communication unit 100 may communicate with the user touch display device in a wired manner using an USB.

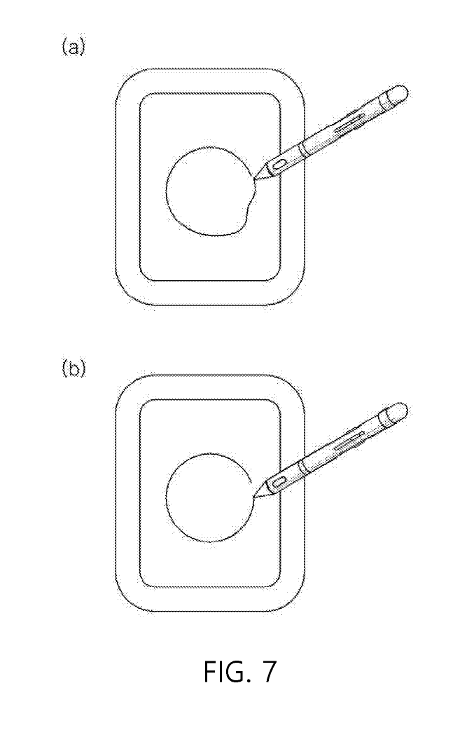

FIG. 7 shows a user touch display device communicatively connected to a touch pen in accordance with one embodiment of the present disclosure. The user touch display device may have a touch panel to allow a touch user input thereto, for example, using the touch pen. The user touch display device may include, but not limited thereto, a notebook computer, a smartphone, a PDA (personal digital assistant), a smartwatch, a tablet, a net-book PC. This user touch display device may typically include a processor and a memory.

The user touch display device may be configured to sense a distance between the touch panel and a tip end of the touch pen using a proximity or distance sensor embedded therein. Thus, the user touch display device may be configured to sense a movement of the tip end of the touch pen when the sensed distance is within the predetermined value and then to display an input thereon corresponding to the movement of the tip end.

For example, the predetermined value may be set to 0.5 cm. When the distance between the touch panel and a tip end of the touch pen is determined to be 0.7 cm, the user touch display device may not sense the movement of the tip end. When the distance between the touch panel and a tip end of the touch pen is determined to be 0.3 cm, the user touch display device may sense the movement of the tip end, and, thus, display an input thereon corresponding to the movement of the tip end. Thus, the user may not contact the touch panel using the touch pen to display an intended input on the user touch display device.

The user touch display device may be configured to display an intended input on the user touch display device based on a combination of the movement of the touch pen and a color input.

To this end, after the touch pen may be paired with the user touch display device using the communication unit 100 thereof over a short distance wireless communication protocol, for example, a Bluetooth, the communication unit 100 may send a user input to the user touch display device. For this, the controller 120 may allow the input data from the user to be sent to the user touch display device.

For color adjustment, the user may select or adjust the color to be rendered on the user touch display device using the color adjustment unit 110 of the touch pen. The color adjustment unit 110 may include at least one moveable member on an elongated body of the touch pen such that the user may contact the movable member to select or adjust the color to be rendered on the user touch display device. The moveable member may be moved between a first position and a second position. When the moveable member is at the first position, a color corresponding to the moveable member is rendered on the user touch display device. When the moveable member is at the second position, the color corresponding to the moveable member is not rendered on the user touch display device.

In this connection, the moveable member may be expressed on the touch pen as the same color as the color corresponding to the moveable member. Thus, the moveable member may have a LED to emit the color corresponding to the moveable member.

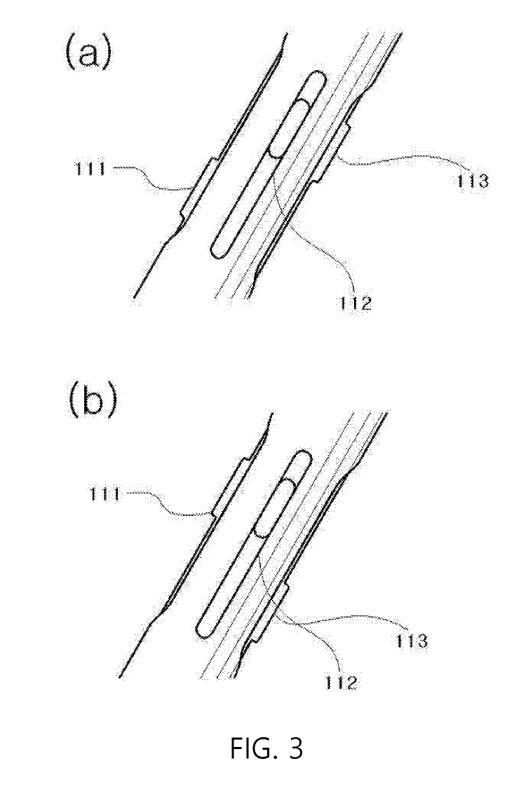

The color adjustment unit 110 may include multiple moveable members on the elongated body of the touch pen. FIG. 3 shows a color adjustment unit of a touch pen in accordance with one embodiment of the present disclosure. In this embodiment, the color adjustment unit 110 may include multiple moveable members 111, 112, 113. Each moveable member may be moved or switched between the first position and the second position. Although in FIG. 3, the number of the multiple moveable members 111, 112, 113 is 3, the present disclosure is not limited thereto. Less or more number of the moveable members may be disposed on the touch pen body. Thus, a single moveable member may be possible.

In one example, the three multiple moveable members 111, 112, 113 may correspond to red, blue, and black colors respectively. However, the colors corresponding to the multiple moveable members may vary depending on a user choice. For example, in FIG. 3, the first position is lower and the second position is upper. Thus, as shown in FIG. 3(a), when the red color moveable member 111 is at the first position, the controller 120 may send instructions to the display device to allow the input from the touch pen to be rendered with a red color on the display panel. This action of the display device may be referred to as a red color rendering. However, when the red color moveable member 111 is at the second position, the controller 120 may send instructions to the display device to disable the red color rendering.

In one embodiment, when the red color moveable member 111 is at the first position, the user may move another color moveable member, for example, the black color moveable member 113 to the first position, the red color moveable member 111 may automatically return to the second position. This result is shown in FIG. 3(b). In general, only one moveable member may be at the first position currently.

In one embodiment, when the red color moveable member 111 is at the first position, the user may move another color moveable member, for example, the blue color moveable member 122 to the first position, both of the color moveable member 111 and the blue color moveable member 122 may be at the first position. In this connection, the controller 120 may send instructions to the display device to allow the input from the touch pen to be rendered with a mixed color between the red and blue colors on the display panel. This action of the display device may be referred to as a mixed color rendering.

In one embodiment, the movable member of the color adjustment unit 110 may be at positons between the first position and second position. The positons between the first position and second position may correspond respectively to values of a line thickness, a color brightness and/or a chroma. Thus, when the movable member of the color adjustment unit 110 are at positons between the first position and second position, the controller 120 may send instructions to the display device to allow the input from the touch pen to be rendered with the values of the line thickness, color brightness and/or chroma corresponding to the positions of the movable member on the display panel.

In one embodiment, the movable member of the color adjustment unit 110 may be at positons between the first position and second position. The positons between the first position and second position may correspond respectively to different colors. Thus, when the movable member of the color adjustment unit 110 are at positons between the first position and second position, the controller 120 may send instructions to the display device to allow the input from the touch pen to be rendered with the different colors corresponding to the positions of the movable member on the display panel.

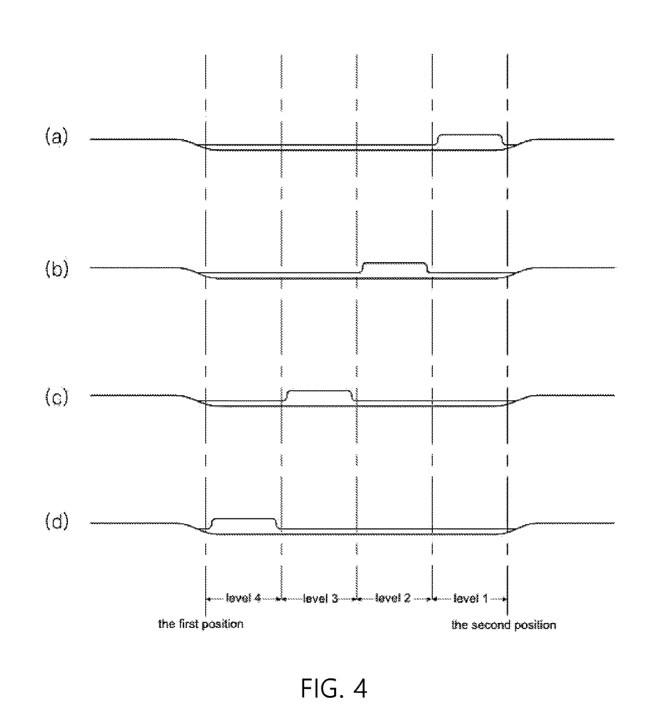

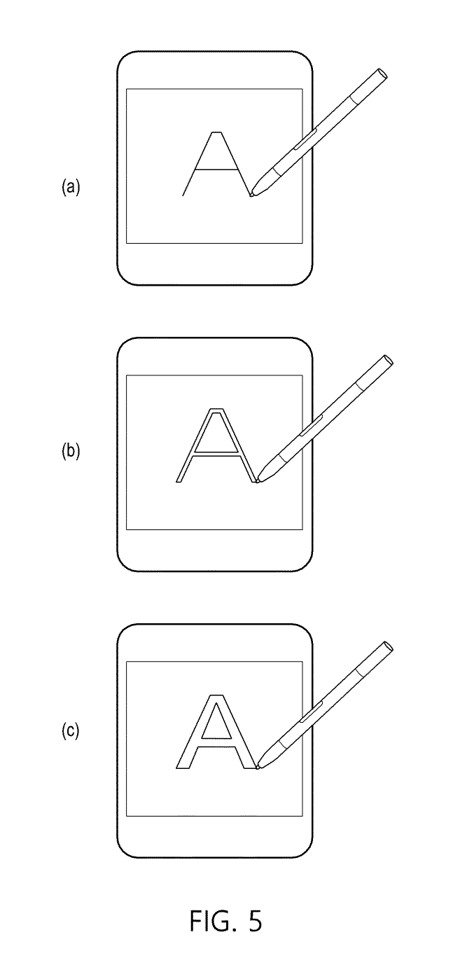

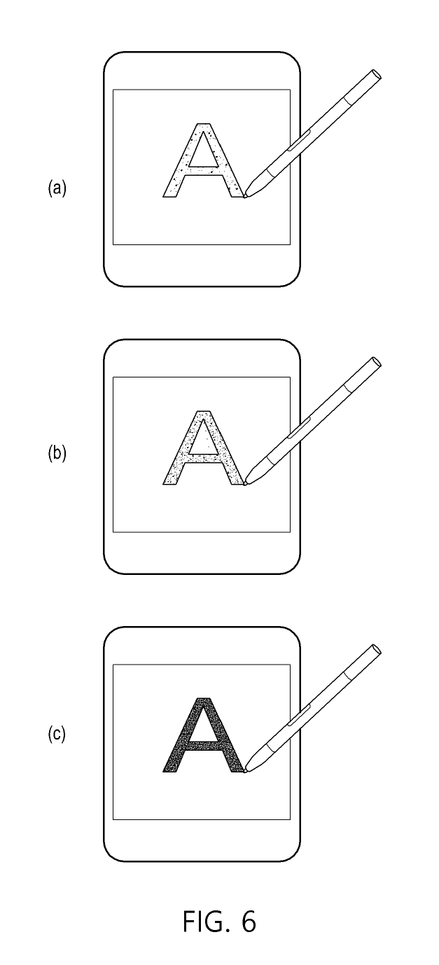

FIG. 4 shows an adjustment method of line thickness, color brightness or chroma using a touch pen in accordance with one embodiment of the present disclosure. FIG. 5 shows states of variable line thicknesses embodied using a touch pen in accordance with one embodiment of the present disclosure. FIG. 6 shows states of variable color brightness embodied using a touch pen in accordance with one embodiment of the present disclosure.

For example, it may be assumed that between the first position and the second position, there are four levels, for example, level 1, level 2, level 3, and level 4 to which the moveable member moves to. Further, as the movable member moves from the level 1 to the level 4, the line thickness may be larger, the color brightness is higher, and/or the color chroma is higher. For example, when the movable member is at the level 1 as shown in FIG. 4, the controller 120 may send instructions to the display device to allow the input from the touch pen to be rendered with a minimum line thickness, a lowest color brightness, and/or color chroma on the display panel. Each state of the movable member at the level 1 to the level 4 may correspond to each state of the (a), (b), (c), and (d) states in FIG. 4.

In this connection, the (b), (c), and (d) states in FIG. 4 may correspond to (a), (b), (c) states of FIG. 5 or FIG. 6 respectively. That is, when the moveable member is at the level 2, the controller 120 may send instructions to the display device to allow the input from the touch pen to be rendered with the line thickness as in FIG. 5(a) or the color brightness as in FIG. 6(a). When the moveable member is at the level 3, the controller 120 may send instructions to the display device to allow the input from the touch pen to be rendered with the line thickness as in FIG. 5(b) or the color brightness as in FIG. 6(b). When the moveable member is at the level 4, the controller 120 may send instructions to the display device to allow the input from the touch pen to be rendered with the line thickness as in FIG. 5(c) or the color brightness as in FIG. 6(c).

Although in FIG. 4 to FIG. 6, between the first position and second position, the four levels are present. However, the present disclosure is not limited thereto. Between the first position and second position, less or more numbers of levels may be present. Further, the values of the line thickness, color brightness and/or chroma corresponding to the levels of the movable member may be different from the above-defined assumption in FIG. 4 to FIG. 6

In FIG. 4 to FIG. 6, when the moveable member moves between the first position and second position, the line thickness, color brightness and/or chroma may vary in a discrete or non-continuous or digital manner. Alternatively, when the moveable member moves between the first position and second position, the line thickness, color brightness and/or chroma may vary in a continuous or analog or non-discrete manner. In this connection, the first position and second position may correspond to maximum and minimum values of the line thickness, color brightness and/or chorma respectively or vice versa.

In one embodiment, a moveable member to allow the adjustment of the line thickness, color brightness and/or chorma may be separate from the moveable member to allow a selectin of the color. In one embodiment, a moveable member to allow the adjustment of the line thickness, color brightness and/or chorma may be act as the moveable member to allow a selectin of the color.

The movement of the moveable member of the color adjustment unit 110 may enable the controller 120 to generate a color adjustment signal. Then, the controller 120 may send the color adjustment signal via the communication unit 100 to the user touch display device, to be specific, a memo application thereof. Thus, the color adjustment signal may enable the display device to allow the input from the touch pen to be rendered with the corresponding color, line thickness, color brightness and/or chorma thereon.

The LED unit 130 may express the color selected by the moveable member. The LED unit 130 may include a LED (Light-Emitting Diode). For example, when the color adjustment unit 110 selects the blue color, the LED unit 130 may express the blue color. In one embodiment, the LED unit 130 may express the light beam having the color brightness and/or chorma selected by the color adjustment unit 110. For example, the LED element may have four levels of the brightness, for example, first to fourth levels. It may be assumed that as the level goes from the first level to the fourth, the LED element emits a brighter light beam. Thus, the (b) state of FIG. 4, and, thus, the (a) state of FIG. 5 or FIG. 6 may correspond to the first level of the beam brightness of the LED element. The (d) state of FIG. 4, and, thus, the (c) state of FIG. 5 or FIG. 6 may correspond to the fourth level of the beam brightness of the LED element.

In one embodiment, the user may use the mode selection unit 140 to allow the user touch display device to be switched between a write mode or erase mode. The mode selection unit 140 may be embodied as a button, a moveable member, touch sensor, etc. to allow the user to select one of the write mode or erase mode. The button, moveable member, touch sensor, etc. may be disposed on the touch pen so as to be touched by the user. In one example, when the mode selection unit 140 is embodied as the touch sensor, a single touch of the user may lead to the write mode and a double touch of the user may lead to the erase mode. In this connection, when the write mode or erase mode is selected using the mode selection unit 140, the controller 120 may generate a mode selection signal to be communicated via the communication unit 100 to the user touch display device.

In one embodiment, the user may select a geometry write mode using the geometry write unit 150. As used herein, the geometry write mode may refer to a mode where when the user touch display device has a geometry input from the touch pen, the processor of the user touch display device may sense the contour of the geometry input and determine a preset complete geometry shape based on the sensed approximate contour and display the determined complete geometry shape thereon. In other words, when the user inputs non-irregular lines or poorly-defined shapes into the touch panel using the touch pen, the processor of the user touch display device may allow the prefect or well-defined lines or shapes to be rendered on the touch display panel.

FIG. 7 shows a user touch display device communicatively connected to a touch pen in accordance with one embodiment of the present disclosure. In particular, FIG. 7 shows the embodiment where the user selects the geometry write mode using the geometry write unit 150. Thus, as shown in FIG. 7(a), the user inputs a poorly-defined circular shape into the touch panel using the touch pen. However, as shown in FIG. 7(b), the processor of the user touch display device may allow the prefect or well-defined circular shape to be rendered on the touch display panel.

In this connection, when the geometry write mode is selected using a geometry write unit 150, the controller 120 may generate a geometry write mode activation signal to be communicated via the communication unit 100 to the user touch display device.

In one embodiment, the geometry write unit 150 may be embodied as a button, a moveable member, touch sensor, etc. to allow the user to select the geometry write mode. The button, moveable member, touch sensor, etc. may be disposed on the touch pen so as to be touched by the user. In one example, when the geometry write unit 150 is embodied as the touch sensor, a single touch of the user may lead to the geometry write mode activation and a double touch of the user may lead to the geometry write mode deactivation.

In accordance with the present disclosure, the touch pen with the color selection or adjustment function may allow the user to control the color, line thickness, color brightness and/or chroma of the user input on the touch display device using the moveable member or button disposed on the touch pen. This may provide the user with the easiness to control the input image or content on the write application, for example, installed on the smart phone or tablet. Further, since the LED of the touch pen emits the color corresponding to the selected color by the moveable member, the user may perceive the selected color intuitively without checking the rendered color on the write application.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A touch pen with a color control function, wherein the touch pen is communicatively paired with a user touch display device, wherein the touch pen allows a user input to be written on the display device via a contact with or a proximity thereof to the display device, wherein the touch pen comprises:
an elongate body;
a communication unit configured to communicate with the user touch display device;
at least one moveable member disposed moveably on the body, wherein the movement of the moveable member on the body controls a color of the user input to be rendered on the display device; and
a controller configured to generate a color control signal corresponding to the movement of the moveable member and to send the color control signal via the communication unit to the touch display device.

2. The pen of claim 1, wherein the moveable member moves between a first position and second position, wherein the movement of the member to one of the first and second positions allows a predetermined color of the user input to be rendered on the display device, and the movement of the member to the other of the first and second positions disables the rendering of the predetermined color of the user input on the display device.

3. The pen of claim 1, wherein the at least one moveable member includes plural moveable members corresponding to different colors respectively, wherein the movements of the moveable members on the body controls the corresponding colors of the user input to be rendered on the display device.

4. The pen of claim 1, wherein the movement of the moveable member on the body selects a color of the user input to be rendered on the display device.

5. The pen of claim 1, wherein the movement of the moveable member on the body adjusts a color brightness, a color chorma and/or a line thickness of the user input to be rendered on the display device.

6. The pen of claim 1, further comprising a LED (light emitting device) to emit a light beam having a color attribute corresponding to a color attribute of the controlled color of the input on the display device.

7. The pen of claim 1, further comprising a mode selection unit to be configured to switch between write and erase modes.

8. The pen of claim 1, further comprising a geometry write unit configured to activate or deactivate a geometry write mode on the touch display device.
